(19) United States
(12) Patent Application Publication
(10) Pub. No.: US 2006/0073756 A1
(43) Pub. Date: Apr. 6, 2006

(54) High visibility polyester fabric for safety apparel applications

(76) Inventors: Ekrem Kayali, Gaziantep (TR); Gregory Ward, Alpharetta, GA (US)

Correspondence Address: GREGORY F. WARD, 11115 ROTHERICK DRIVE, ALPHARETTA, GA, 30022, US

(21) Appl. No.: 10/956,754

(22) Filed: Oct. 1, 2004

(51) Int. Cl. D04H 3/16; B32B 27/04; B32B 27/12; D04H 3/00; B32B 5/02

(52) U.S. Cl. 442/401; 442/414; 442/364; 442/136

(57) ABSTRACT

A high visibility fabric for use in safety apparel comprising a nonwoven web material and fluorescent pigment. The fluorescent pigment concentration in the fabric is greater on the outer surface of nonwoven web material due to preferential thermal treatment of the outer surface before or after web formation.

### BACKGROUND OF THE INVENTION

1. Field of the Invention

The safety of people who work or exercise near motor vehicle traffic can be significantly improved by wearing apparel that highlights the person's presence to passing motor vehicles. To promote the safety of roadway workers and pedestrians, apparel manufacturers commonly produce bright or fluorescent colored apparel to make the wearer more conspicuous.

This invention relates to high visibility fabric produced from a spunbond polyester web material with relatively low fluorescent pigment content. The fabric is used for manufacturing safety apparel requiring high visibility. Visibility is excellent despite reduced pigment content because process conditions induce pigment migration to the fiber surface.

2. Prior Art

Articles of apparel are colored to provide enhanced contrast for better daytime visibility. Frequently, fluorescent colors are used in conjunction with retroreflective sheeting or decals to make the fabric more conspicuous under daytime viewing conditions as shown in U.S. Pat. No. 3,830,682 to Rowland, U.S. Pat. No. 5,387,458 to Pavelka, et al., and U.S. Pat. No. 5,695,853 to Billingsley, et al.

A high visibility fabric having a non-woven web material with a fluorescent layer is the subject of U.S. Pat. No. 5,695,853 to Billingsley, et al. The fluorescent layer consists of fluorescent pigment in a cross-linked resin bonded to the non-woven web to create a concentration of fluorescent pigment proximate a designated outer surface of the non-woven web. The fabric is used for manufacturing safety vests, signage, and other articles requiring high visibility. It is complex to produce. U.S. Pat. No. 5,888,651 to Hoyt, et al. describes the use of bicomponent fibers in the production of fluorescent non-woven web material.

The use of fluorescent apparel for safety applications is well known. These products typically utilize woven fabric with fluorescent pigments. Generally these fabrics are heavy in areal weight (grams per square meter and contain either a high concentration of fluorescent pigment, or a coating of fluorescent material on only one surface.

In U.S. Pat. No. 5,478,628 to Billingsley, et al. a high visibility fabric having a non-woven web material with a fluorescent layer is described. The fluorescent pigment concentration in the fabric is greater proximate a designated fabric outer surface than at other outer surfaces of the fabric. This system requires a relatively complicated process. U.S. Pat. No. 5,695,853 to Billingsley, et al. also describes a high visibility fabric that includes a web of fibrous material and a fluorescent layer. The web has first and second major surfaces, and the fluorescent layer includes fluorescent pigment in a cross linked resin. The resin penetrates into the web to surround the fibers and is bonded thereto, but the fluorescent pigment is concentrated at the first major surface at a level greater than at the second major surface. Because the pigment concentrates at the one surface, less pigment is reportedly used in producing a fluorescent colored fabric. It is not clear from these two patents if the reduction in pigment use is significant. There is also no indication if these low pigment fabrics meet the performance standards and guidelines for high-visibility luminescent safety apparel as promulgated by the American National Standards Institute

### BACKGROUND OF THE INVENTION

Authorities worldwide have recognized the need to protect occupational workers from the inherent hazards of apparel that is deficient in contrast and visibility when worn by workers exposed to the hazards of low visibility. These hazards are further intensified by the often-complex backgrounds found in many occupations such as traffic control, construction, equipment operation, and roadway maintenance. Of major concern is ensuring that these workers are recognized by motor vehicle drivers in sufficient time for the drivers to slow-down or take other preventive action to avoid hazard or injury to the workers. Thus, worker safety is jeopardized when apparel not designed to provide persons working in such dangerous environments wear visual identification. While there are no federal regulations governing the design, performance, or use of high-visibility apparel, local jurisdictions and private entities have undertaken to equip their employees with highly luminescent vests. One national standards organization, known as the American National Standards Institute (ANSI), in conjunction with the Safety Equipment Association (ISEA), has developed a standard and guidelines for high-visibility luminescent safety apparel based on classes of apparel.

Because there were no federal regulations governing the standards of high-visibility safety apparel prior to 1999, two organizations set out in a joint venture and, during that year, developed guidelines for high-visibility safety apparel. The two organizations were ANSI, American National Standards Institute, and ISEA, International Safety Equipment Association. ANSI/ISEA created a standard, 107-1999, which governs the luminescent, color, and reflective qualities of a safety fabric. Taking this one step further, ANSI/ISEA differentiated between the activities and work environment of the wearer, and decided upon three Classes of conspicuity required for certain situations, with Class III providing the highest degree. Class I is usually worn by persons in a non-complex background where traffic does not exceed 25 mph, whereas in Class II traffic exceeds 25 mph and weather conditions vary. Class III provides high-visibility for workers in complex backgrounds with traffic exceeding 50 mph. Classes are based on a garment having a specified amount of reflective area.

### PRIOR ART

The present invention is directed to a fabric that meets the minimum guidelines laid out in ANSI/ISEA-107-1999, “American National Standard for High-Visibility Safety Apparel.

ANSI/ISEA-107-1999 specifies requirements for apparel capable of signaling the wearer's presence visually and intended to provide conspicuity of the wearer in hazardous situations under any light conditions by day and under illumination by vehicle headlights in the dark. As used herein, and as defined in ANSI/ISEA-107, “conspicuity” refers to the characteristics of an object that determine the likelihood that it will come to the attention of an observer, especially in a complex environment which has competing foreground and background objects. Conspicuity is enhanced by high contrast between the apparel and the background against which it is seen. The ANSI standard specifies performance requirements for color, luminance, and reflective area. Three different colors for background and combined performance are defined in the standard. The color selected should provide the maximum contrast with the anticipated background for use of the apparel. Several combinations are described in the standard depending upon the intended use. For example, the ANSI standard describes three classes of conspicuity. For utility workers, the apparel would meet either Class 2 or Class 3 (Appendix B of ANSI 107-1999).

### SUMMARY OF THE INVENTION

The invention is a high visibility fabric comprising a spunbonded polyester web material with fusibly interbonded thermoplastic fibers containing a fluorescent pigment and produced using a novel method for increasing color intensity while minimizing pigment consumption.

It was discovered that when the surface of the polyester web is heated to at least 240 degrees C. the pigment migrates towards the web surface. The amount of pigment migrated was found to be time and temperature sensitive. Pigment migration increases the color at the web surface. Pigment migration as measured by increase in color intensity is proportional to temperature.

Several advantages accrue from this technique. The primary advantage is that color intensity and brightness can be maximized using less pigment and thus with subsequent lower cost per kilogram of finished nonwoven. Other advantages may include lower manufacturing costs. Lower costs can lead to disposability after a single use. Single use disposability improves the overall cost of use compared to those situations where the apparel must be laundered after one or two uses. This is based on the economic analysis where all costs including handling, transportation, washing and redistribution are included. In addition it is well known that multiple washings typically reduce color intensity due to fading. This mechanism also works with core and sheath bicomponent fibers wherein the pigment is concentrated in the sheath.

A preferred non-woven web material comprises the fusibly interbonded and pigmented polyester fibers as described above wherein the conditions of fiber spinning and subsequent thermal bonding of the web favor the migration of the fluorescent pigment to the fiber surfaces such that the fabric thus prepared has a brighter and more intense color than available through normal spin bonding techniques.

The fabric thus created is less expensive relative to woven materials, lightweight, exhibits high visibility in daylight and under artificial illumination, is washable and can be converted into safety apparel by a variety of commercially available heat bonding methods.

Three methods of manufacturing high visibility fabrics are disclosed comprising the steps of extruding a spunbonded polyester non-woven web material containing a low percentage of fluorescent or ultra-bright non-fluorescent pigment in the web. A suitable flame retardant may also be added. Example 1 is considered the best mode.

### BRIEF DESCRIPTION OF THE DRAWING

FIG. 1 is a schematic of the web production system.

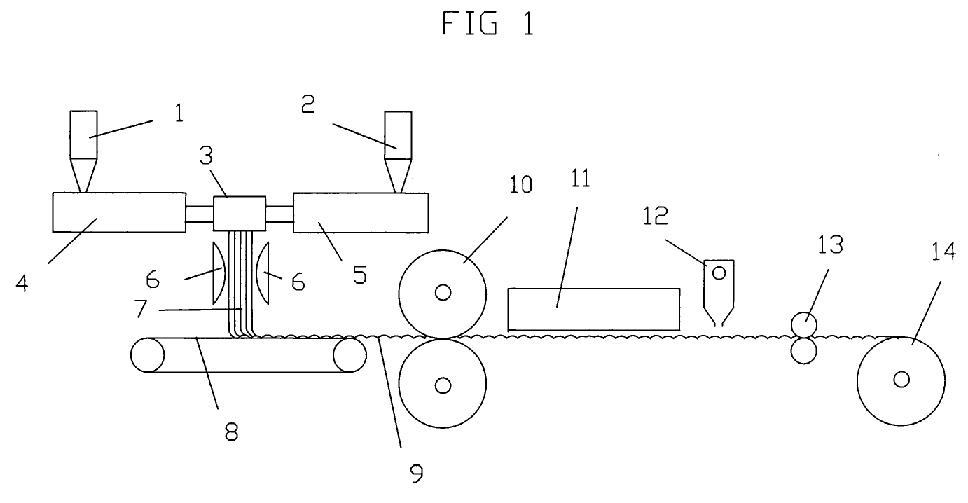

### DETAILED DESCRIPTION OF THE INVENTION

### EXAMPLE 1

A brightly colored high visibility spunbonded polyester non-woven fabric is manufactured as described above using a fluorescent pigmented masterbatch polyester polymer which is proportionately fed into the unpigmented feed to the spunbond extruder feed hopper 1 at a rate such that the finished web will have a pigment content of 3% or less by weight. The pigmented feed enters the primary extruder 4, which mixes and blends the pigmented and unpigmented polyesters into a homogeneous melt. The melt is fed into the spin die 3 under pressure.

The melt is then extruded through the die orifices and drawn down through the slot drawing system 6. Fibers 7 are deposited on the conveyor screen 8 and the resultant web 9 is thermally bonded in the patterned point-bonding calender 10 at a temperature of about 220° C. At this juncture the upper surface of the web is carried under a multi-pass outer-surface infrared heating system 11 or other outer-surface heating means such as a heating can stack or a vertical infrared heating array. Surface temperature measuring and control systems maintain the web 9 surface at a maximum of 270° C. for a minimum of 0.5 minutes to a maximum of 1.8 minutes.

It is extremely important that the web surface heating means must be designed to heat only the outer surface of the web in order to prevent reverses of pigment migration. It should be noted that the heating means could also be located before the bonding calender 10.

After the web exits the outer-surface heating means the web surface is cooled by a cooling means such as a forced air fan 12. The forward motion of the web is aided by a pull roll set 13 which is controlled to minimize tension in the outer-surface infrared heating system 11 or other outer-surface heating means.

The web exiting the pull roll set 13 continues to the product winder 14.

### EXAMPLE 2

A brightly colored high visibility spunbonded polyester non-woven fabric is manufactured using a fluorescent pigmented masterbatch polyester polymer which is proportionately fed into the unpigmented feed to the spunbond extruder feed hopper 1 such that the final pigment amount in the finished fabric is 3% or less. The pigmented feed enters the primary extruder 4, which mixes and blends the pigmented and unpigmented polyesters into a homogeneous melt. The melt is fed into the spin die 3 under pressure.

The melt is then extruded through the die orifices and drawn down through the slot drawing system 6. Fibers 7 are deposited on the conveyor screen 8 and the resultant web 9 is thermally bonded in the patterned point-bonding calender 10 at a temperature of up to 270° C. Surface temperature measuring and control systems maintain the web 9 surfaces at a minimum of 240° C. for a minimum of 0.3 minutes after exiting the bonding calender 10 by controlling the heat input to the calender. The web then continues to the product winder.

### EXAMPLE 3

Another method of manufacturing high visibility fabric is disclosed which is also suitable for large scale manufacturing of the fabric. This method utilizes a spunbonded fabric produced from bicomponent polyester fibers. This example uses the bicomponent fiber system to reduce overall fluorescent pigment usage by concentrating the pigment in the sheath of the fiber rather than uniformly through the fiber as in Examples 1 and 2.

In this example the outer layer or sheath resin of the bicomponent polyester fiber may have a lower melting temperature than the core polyester resin for improved bonding although it is not necessary. Only the outer sheath layer contains the pigment, which can be fluorescent or ultra-bright non-fluorescent. This along with the instant invention permits reduced total pigment usage by concentrating the pigment in the sheath. The sheath layer polyester may also be of the same melting temperature as the core wherein the sheath functions simply as a pigment carrier.

The bicomponent fibers may have from about 20% to about 80%, preferably from about 40% to about 60%, by weight of the core polymer and from about 80% to about 20%, preferably about 60% to about 40%, by weight of the sheath polymer. In the instant example the sheath is 50% of the fiber weight and the core is 50% of the fiber weight.

A brightly colored high visibility spunbonded polyester non-woven fabric is manufactured as described above using a fluorescent pigmented masterbatch polyester polymer which is proportionately fed into the unpigmented feed to the spunbond extruder feed hopper 1 such that the final pigment amount in the finished fabric is 1.5% or less by weight. The pigmented feed enters the primary or sheath extruder 4, which mixes and blends the pigmented and unpigmented polyesters into a homogeneous melt. The sheath melt is fed under pressure into the sheath side of a bicomponent spin die 3 at a rate equal to that of the core melt.

Polyester polymer is proportionately fed into the spunbond extruder feed hopper 2. The un-pigmented feed enters the secondary or core extruder 5 which mixes and blends it into a homogeneous melt which is fed under pressure into the core side of the bicomponent spin die 3. The core of the bicomponent fiber contains no pigment.

The core and sheath melts are then extruded through the die orifices and drawn down through the slot drawing system 6. Bicomponent fibers 7 are deposited on the conveyor screen 8 and the resultant web 9 is thermally bonded in the patterned point-bonding calender 10 at a temperature of up to about 250° C. At this juncture the web may be sent directly to the finished product winder 14 or it may go through post calender surface heating system wherein the upper surface of the web is carried under a multi-pass outer-surface infrared heating system 11 or other outer-surface heating means such as a heating can stack or a vertical infrared heating array. Surface temperature measuring and control systems maintain the web 9 surface at a maximum of 270° C. for a minimum of 0.2 minutes to a maximum of 1.8 minutes.

After the web exits the outer-surface heating means the web surface is cooled by a cooling means such as a forced air fan 12. The forward motion of the web is aided by a pull roll set 13 which is controlled to minimize tension in the outer-surface infrared heating system 11 or other outer-surface heating means. The web exiting the pull roll set 13 continues to the product winder.

We claim:

1. A high visibility fabric that comprises;
a spunbonded polyester web comprised of fusibly interbonded thermoplastic fibers;
wherein said fibers contain a fluorescent pigment;
wherein a significant amount of said pigment has migrated to said fiber surface as a result of the application of heat to the top surface of said web by a heating means for a period of time after said web is bonded.

2. The fabric of claim 1, wherein the fabric has a total areal density of between 15 grams per square meter and 200 grams per square meter.

3. The fabric of claim 1, wherein said fabric contains less than 4% of said pigment, by weight, per square meter of said fabric.

4. The fabric of claim 1, wherein said fabric contains between 1.5% and 9% of said pigment, by weight, per square meter of said fabric.

5. The fabric of claim 1, whereby said heat treatment is performed before bonding.

6. The fabric of claim 1, wherein thermal treatment is performed at a temperature of 270° C. or less.

7. The fabric of claim 1 wherein thermal treatment is performed for maximum of 1.8 minutes

8. The fabric of claim 1 wherein said fibers are bicomponent fibers with a total fluorescent pigment concentration of 2% or less of the areal weight per square meter.

9. The fabric of claim 8 wherein said bicomponent fibers have a sheath-to-core ratio of about 50% by weight wherein the sheath contains all of said fluorescent pigment and the core is pigment free

10. The fabric of claim 8 wherein said bicomponent fibers have a sheath-to-core ratio of about 25% to about 75% by weight wherein the sheath contains all of said fluorescent pigment and the core is pigment free

11. The fabric of claim 1 further comprising a flame retardant material.
